(19) United States
(12) Patent Application Publication
(10) Pub. No.: US 2020/0160384 A1
(43) Pub. Date: May 21, 2020

(54) Event System Leveraging User's Mobility Behavior

(71) Applicant: Bayerische Motoren Werke Aktiengesellschaft, Muenchen (DE)

(72) Inventors: Guy DUNCAN, Munich (DE); Olaf NIEBISCH, Neufahrn bei Freising (DE); Jilei TIAN, Chicago, IL (US); Yang CAO, Chicago, IL (US)

(21) Appl. No.: 16/198,184

(22) Filed: Nov. 21, 2018

(51) Int. Cl. G06Q 30/02; G06N 5/02; H04W 64/00; H04W 4/20; G06N 20/00

(52) U.S. Cl. CPC G06Q 30/0254; G06Q 30/0261; G06N 20/00; H04W 64/006; H04W 4/20; G06N 5/022

(57) ABSTRACT

A system, method, and non-transitory computer-readable medium are provided which track mobility of a user via a vehicle and/or a portable electronic device to automatically and proactively provide enhanced service information to the user based on changes in behavior of the user. According to the method, data indicating a behavior pattern of the user is received from a memory, the mobility of the user is continuously tracked, and a determination is made of whether a change occurs in the behavior pattern of the user based on the mobility of the user. When it is determined that a change has occurred, a determination is made of the type of change in the behavior pattern, and based on the type of change, the service information is outputted to the user and/or a third party such as a financial service provider and the behavior pattern is periodically adapted according to the user's feedback.

### BACKGROUND AND SUMMARY OF THE INVENTION

The present invention relates to a system, method, and non-transitory computer-readable medium for leveraging changes in a user's mobility behavior to enhance the user's experience by automatically providing enhanced service information to the user based on the changes in mobility.

In conventional behavior pattern systems, a user's behavior patterns are determined by monitoring a user's data from a device, such as a vehicle. In the case of a vehicle that is used by the user, conventional behavior pattern systems collect data in order to train a predictive model for the user's regular mobility pattern that can be used, for example, to predict the user's next trip based on the user's commute pattern.

Conventional systems, however, do not automatically determine and evaluate changes in the user's behavior patterns in order to provide the user with enhanced service offerings to more closely meet the needs and capabilities of the user as they change over time. Thus, the present invention provides improvements over conventional behavior pattern systems by automatically determining changes in the user's behavior patterns and providing enhanced service offerings to the user based on the type of changes in the user's behavior patterns.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a schematic block diagram of a system according to an embodiment of the present invention.

FIG. 2 illustrates a system diagram corresponding to FIG. 1.

FIG. 3 illustrates an embodiment of a mobility behavior modeling framework according to the present invention.

FIG. 4 illustrates an embodiment of a two level hierarchical hidden Markov model (HMM) used to model a user's behavior according to the present invention.

FIG. 5 illustrates an example of an observation sequence according to the present invention.

FIG. 6 illustrates a flow chart of an embodiment of a method according to the present invention.

### DETAILED DESCRIPTION OF THE DRAWINGS

In accordance with the present application, it is assumed that a user's mobility activity data is driven by the user's behavior patterns. The user's mobility activity data is observable, but the behavior patterns are generally hidden. In the present invention, a behavior model is defined that generates the mobility activity data, from which the behavior model is reversely estimated using observable activity data.

A user's daily mobility pattern is described by states, such as a workday pattern (e.g., Monday through Friday) and a weekend pattern (e.g., Saturday through Sunday). A workday pattern is described by a sequence of mobility including, for example, home in the morning→commute to work→stay in the office→optional short travel to meeting during workday→commute to home→optional shopping, social, or exercise→sleep overnight at home. According to the reference implementation in the present invention, behavior patterns such as this can be modeled by a hierarchical hidden Markov model (HMM) or other model.

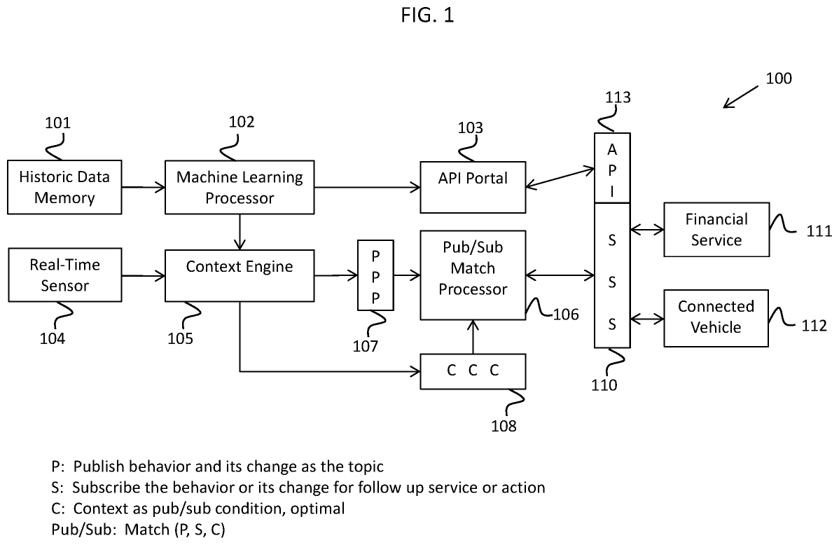

FIG. 1 illustrates a schematic block diagram of a system according to an embodiment of the present invention. As illustrated in FIG. 1, the system uses historical data stored in a memory 101 related to a user and his or her mobility as well as real-time sensor and/or user iteration data about the user's mobility in order to provide service information to the user. The memory 101 can be any kind of non-transitory memory, such as random access memory (RAM), read-only memory (ROM), flash memory, a hard disk, a CD, a DVD, and cloud storage. The historical data is used offline in a machine learning processor 102 to perform machine learning of a user's behavior patterns. The processor can be any type of processor, such as a field programmable gate array (FPGA), application specific integrated circuit (ASIC), central processing unit (CPU) and/or a microprocessor. The output of the machine learning processor 102 includes user behavior pattern information that can be provided to an application program interface (API) portal 103 for outputting to the user via the API 113. Also, the output of the machine learning processor 102 can be provided to a context engine 105 for use in the processing of real-time sensor data captured by a real-time sensor 104.

A user's devices, e.g., vehicle, mobile phone, etc., can collect real-time sensor data regarding the mobility of the user via the real-time sensor 104. This data can be collected, for example, from a telemetry data system in the vehicle, such as a GPS system. Thus, the days and times during which the user's vehicle is located at particular locations and movements of the vehicle between locations can be monitored. A typical user is likely to have a home location, a work location, and one or more travel locations. One of the user's behavior patterns involves a regular commute pattern, i.e., from home to work and from work to home. The user's initial behavior patterns can be based on the historical data, but the initial behavior patterns are continuously or periodically updated based on the real-time sensor data to refine the behavior patterns.

The real-time sensor data is output to the context engine 105, which also receives behavior pattern data of the user based on the historical data from the machine learning processor 102. The context engine 105 compares the behavior pattern data to the real-time data to determine when changes in the behavior patterns occur. The context engine 105 publishes (P) behaviors and changes thereto 107 as topics in a publish/subscribe (pub/sub) messaging pattern. The API Interface can be used as the interface for the user's regular behavior, while the pub/sub messaging platform can be used as the event-oriented interface for the user's behavioral changes including abnormal behavior. Also, the context engine 105 outputs context (C) information 108 as a pub/sub condition. A pub/sub match processor 106 performs a pub/sub match between a published behavior and a subscriber (S) for a particular context. Subscriber information 110 can come from a variety of services, e.g., a financial service provider 111, a connected vehicle 112 (vehicle service provider), and the like.

As an example, a behavior pattern can be used as a context in order to predict that the user will leave his or her current location at a particular time (e.g., in 20 minutes). The system can determine whether the user is traveling on his or her regular commute. A sensor can be used as a context to determine, for example, whether the vehicle is parked or is low on fuel.

According to an alternative embodiment, the real-time sensor data is collected from a mobile device, such as a smart phone, of the user. Further, the real-time sensor data can be concurrently collected from a plurality of devices, such as a vehicle and a smart phone. In order to identify changes in the user's behavior patterns, the real-time sensor data can be compared to the user's stored behavior pattern data.

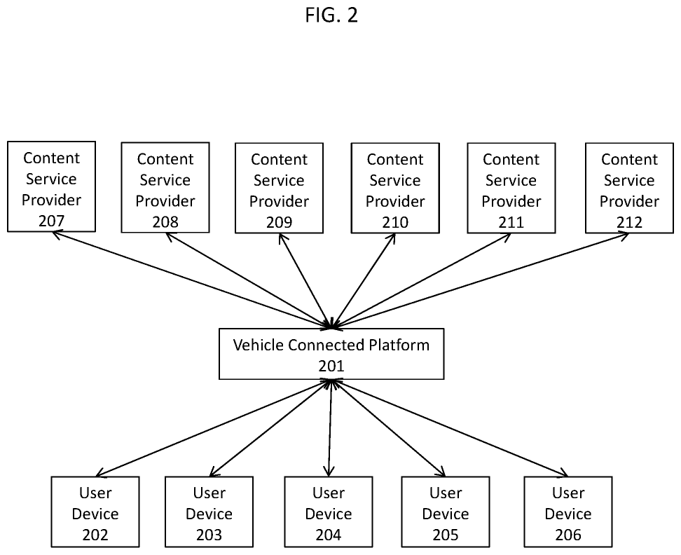

The operation of the system 100 is described below in relation to FIGS. 2 through 6. As illustrated in FIG. 2, an exemplary embodiment of the system 100 includes a vehicle connected platform 201, including the core technology for contextual and personal service, which communicates with user devices 202 through 206 that provide a holistic consumer experience and content service providers 207 through 212 that provide focused business value to the user. The user devices 202 through 206 can include one or more of an iPhone, an android phone, a vehicle head unit, an in-home service such as Amazon's Alexa or Microsoft's Cortana, a smart watch, and the like. The content service providers, by way of example only, can include Yelp, Amazon, Spotify, Microsoft, Google Maps, weather service, and a vehicle battery charging service. The system, however, is not limited to this configuration and different numbers and types of user devices, service providers, etc. can be included in the system. As described above, mobility data of the user can be obtained from one or more of the user devices 202 through 206 and subscriber information can be obtained from one or more of the content service providers 207 through 212.

As described above, the user's mobility behavior change or abnormal behavior are recognized by the sequence modeling in the system as part of the user's context and event discovery. In general, the pub/sub messages are used to offer enhanced services to the user based on the user's mobility behavior change, i.e., IF (context) PUBLISH (abnormal or regular event) THEN SUBSCRIBER (action). As a specific example, IF (vehicle maps to two user IDs and vehicle data is generated from user 1 and then user 2 AND user 1 and user 2 have different home and work locations) PUBLISH (user 1 likely sold the vehicle to user 2) THEN SUBSCRIBER (vehicle service provider (e.g., BMW Connected) asks user 1 to delete their app and/or account). As another example, IF (user keeps same home AND no longer visits work AND no vacation) PUBLISH (user lost their job) to warn a financial service provider that the user might have a financial challenge THEN SUBSCRIBER (financial service provider (e.g., BMW Financial Services) to take an action). Here the action could be to offer a reduced service package to the user that is less expensive or to ask the user if they would like to cancel their services in order to reduce their financial burden.

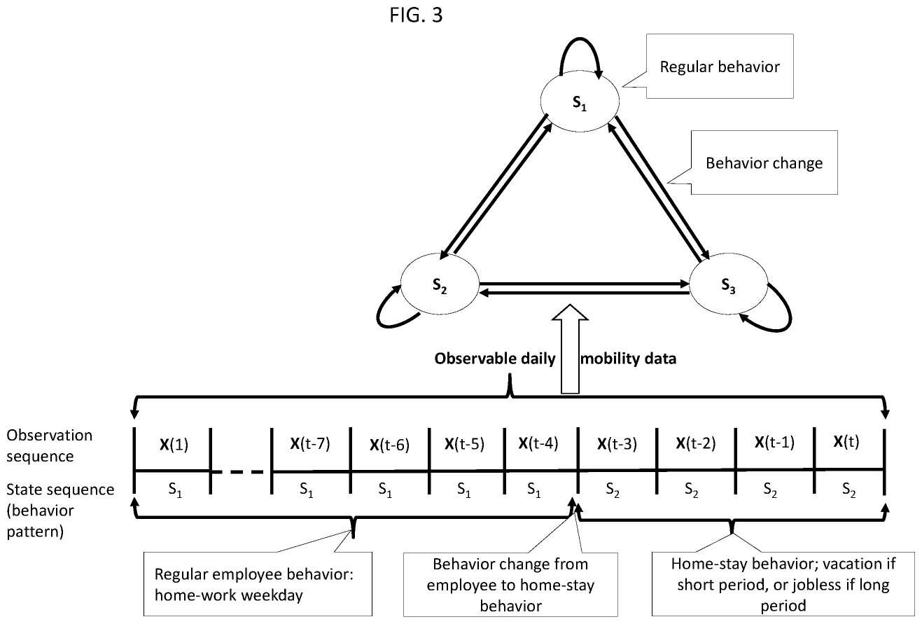

FIG. 3 illustrates an embodiment of a mobility behavior modeling framework according to the present invention. In this exemplary embodiment, there are three states (S₁, S₂, and S₃) but the invention is not limited to three states or the HMM modeling approach described herein. Behavior represented by the states S₁ (home-work), S₂ (home-stay), and S₃ (travel) is considered to be regular behavior. The transitions between the states represent behavior changes.

User observable mobility data is represented as X(t) in FIG. 3. The user's behavior is modeled as states (Sₜ) that are not explicitly observable but are an intrinsic generator for mobility data. The transition probabilities between states of behavior changes or abnormal behavior depend on the previous state and are represented by the expression p(Sₜ=i|Sₜ₋₁=j,Θ). Emission probabilities that model regular behavior such as travel depend only on the current state and are represented by the expression p(Xₜ|Sₜ=i, Θ), where Xₜ is an observation.

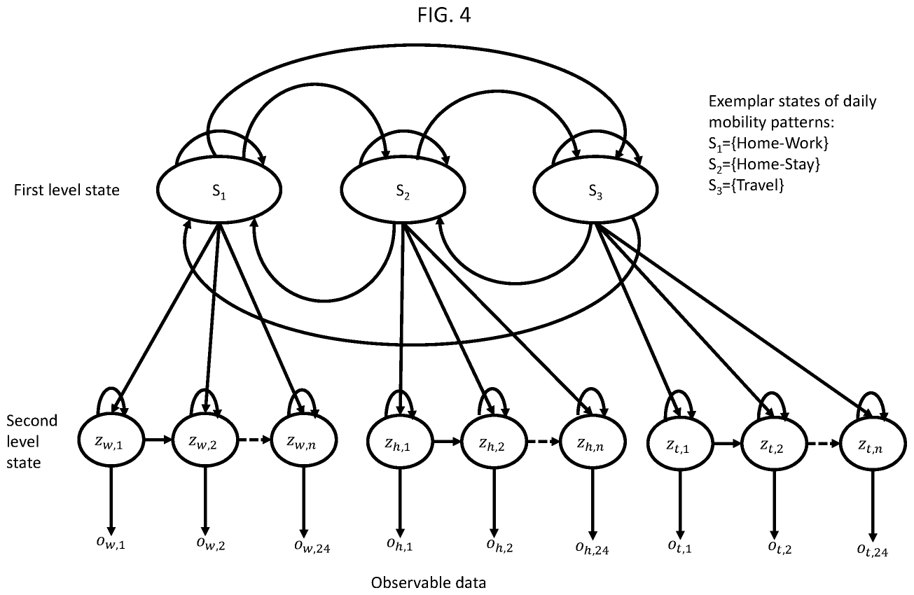

FIG. 4 illustrates an embodiment of a two level hierarchical hidden Markov model (HMM) used to model a user's behavior according to the present invention. In the model, the user's daily activity is converted to symbol sequences. The symbols may include, for example, home, work, learned frequent destination, new location near home-work region, new location far away from home-work region, and moving.

Periodically, such as every hour, the system obtains the most significant stay location in which the user has stayed. If there are no significant stay locations, the symbol is mapped as “moving.” When the stay location belongs to home, work, or learned frequent destination, the corresponding symbol is used. In a case in which the stay location is new and the distance to the home-work region is less than a predefined threshold (e.g., 40 km), the mapped symbol could be “new location near d” where “d” means the dth new nearby location on the current date. In a case in which the stay location is new and the distance to the home-work region is greater than the threshold, the mapped symbol could be “new location outside d” where d means the dth new outside location on the current date. Other features can also be introduced for different tasks.

According to the present invention, the user's mobility data in one day is mapped into a fixed length symbol sequence. The daily home-work information can be encoded with a home and work confidence score and an indication of whether the home location changed or whether the work location changed. In a case in which one or both of the home location and the work location have changed, a consequence of other changes are likely to occur, such as the user taking vacation, moving to another place to work, etc.

The system according to the present invention proactively reaches out to the user to offer services tailored to the user's life as changes occur. For example, in a case in which the user has sold the vehicle, then the service provider is notified so that it reminds the user to delete personal data and the account if it has not been done yet. For another example, in a case in which the user lost their job, the vehicle service provider is notified so that a reduced (less expensive) level of services can be offered to the user with a corresponding lower monthly fee. On the other hand, when it is determined that the user has a new home that has a higher value than the user's old home or the user has a new job that pays more than the user's old job, financial services can be correlated with these changes to inform the user of options for a higher level of service or purchasing a more expensive vehicle. In one embodiment of the invention, a determination of a financial change in a user's life based on the determined mobility changes results in a notification being sent to financial services provider and/or the vehicle service provider so that an analyst can further analyze the changes in the user's life.

The two level hierarchical hidden Markov model (HMM) shown in FIG. 4 models the user's daily state and anomaly detection, but other sequence modeling, such as long short term memory (LSTM) can apply also. The first level states illustrated in FIG. 4 include S₁ (home-work), S₂ (home-stay), and S₃ (travel), but other states can be modeled as well. The transition probabilities between states follow the Markov chain property in that the transition only depends on the previous state, i.e., p(Sₜ=i|Sₜ₋₁, . . . S₁,Θ)=p(Sₜ=|Sₜ₋₁,Θ). In the reference model, a full probability connection exists between every two nodes (including self transition). The first level hidden state emits a sequence of second level hidden states such as z_{w,i} and the emission probability is represented as p(zt|St=i,Θ). Although the first level states are modeled by an HMM, they could also be modeled using another model such as recurrent neural network, and the like. The second level hidden state z emits sequence observations where the observation means the daily activity sequences, where the emission probability is p(oₜ|zₜ,Θ).

According to the present invention, the model takes advantage of offline training and an online algorithm. The system collects a user's historical mobility data labels such as Workday, Weekend, Travel, etc. The offline training provides first level hidden states and final observation sequences to estimate the transition probability between second level hidden states and the probability of emitting observations. The offline training also provides for estimating the transition probability of first level hidden states and emission probability between first and second level hidden states.

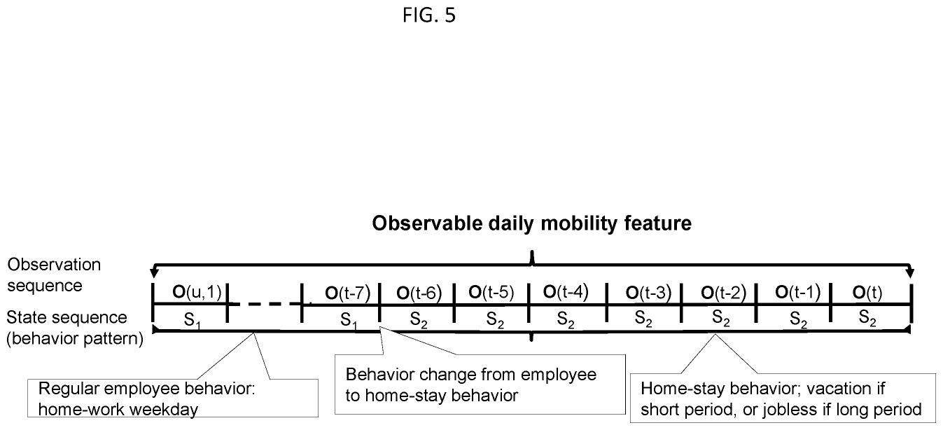

As illustrated, for example, in FIG. 5, the online algorithm extracts a feature sequence o_{u,t} on the current date t as activity sequences and home-work information. The feature sequence o_{u,1} . . . o_{u,t-1} and a state align history are retrieved. According to the present invention, a Viterbi algorithm is used to find hidden state s_{u,t} using observation sequence o_{u,1} . . . o_{u,t-1}, state alignment with observation history, and o_{u,t}. The feature_{u,t} information and related information are updated iteratively, where s_{u,1} . . . s_{u,t} shows the user's daily states. The Viterbi algorithm is used to find the best alignment between observations and states. For each state, the system offers regular user mobility behavior via the API. For changes of state, the system offers the user behavior change as an event by publish, optionally with context as a condition. An inference confidence can be measured by total Viterbi score probability p(o_{u,t}|s_{u,t}). If p(o_{u,t}|s_{u,t})<λ, which means the possibility to observe o_{u,t} for matched state sₜ is very low, where λ is a threshold estimated in offline training, a possible anomaly behavior is indicated.

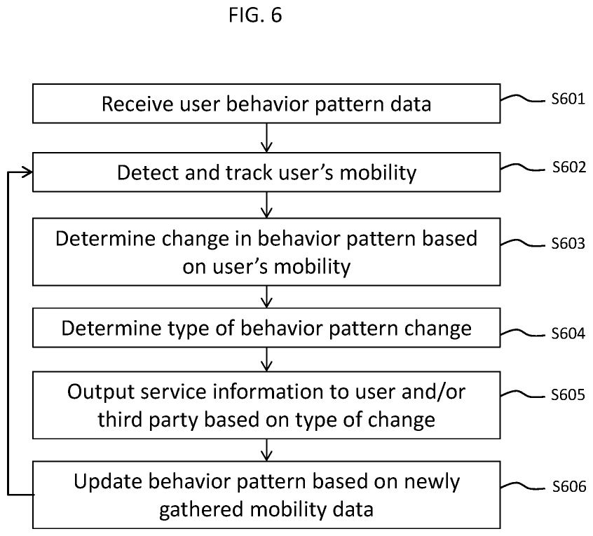

FIG. 6 illustrates a flow chart of an embodiment of a method according to the present invention. In step S601, user behavior pattern data is received by the machine learning processor 102 from the memory 101. The user's mobility is tracked in step S602 by a real-time sensor 104 via the user's vehicle, a mobile device of the user, or the like. By comparing historical data of the user's behavior pattern and real-time data of the user's mobility in step S603, the context engine 105 determines when changes in the user's behavior pattern occur. Additionally, in step S604, the context engine 105 determines the type of change in the behavior pattern, such as a change in home location, work location, commute pattern, and the like.

Based on the determined type of change in the user's behavior pattern, in step S605, updated service information from the vehicle service provider 203 is outputted to the user and/or a third party such as a financial service provider 204. Further, the system can output other data, such as mobility graphs of the user's mobility, recommendations for new places to go near a new home or work location, and the like. In order to continuously refine the user's behavior pattern, in step S606, the historical behavior pattern data is adapted based on newly acquired mobility data. Moreover, the process continuously repeats the steps of the method in order to continue to automatically provide updated and enhanced service information to the user.

In another exemplary embodiment of the present invention, a non-transitory computer-readable medium is encoded with a computer program that performs the above-described method. Common forms of non-transitory computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, or any other medium from which a computer can read.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for automatically and proactively providing enhanced service information to a user based on changes in behavior of the user, comprising:
receiving, from a memory, data indicating a behavior pattern of the user;
monitoring mobility of the user by monitoring movements of at least one of a vehicle and a mobile telecommunication device of the user;
determining whether a change occurs in the behavior pattern based on the mobility of the user;
determining a type of the change in the behavior pattern; and
outputting the updated service information to at least one of the user and a third party based on the type of the change.

2. The method according to claim 1, wherein, when the mobility of the user is determined by monitoring the movements of the vehicle, the mobility is determined based on telemetry data of the vehicle.

3. The method according to claim 1, further comprising:
adapting the behavior pattern based on newly acquired mobility data.

4. The method according to claim 1, wherein outputting the updated service information includes providing a notification to the user via at least one of an audio output in a vehicle, a text message to a mobile communication device, and an e-mail to the user.

5. The method according to claim 1, wherein the change in the behavior pattern is determined based on a change in at least one of a home location and a work location of the user.

6. The method according to claim 5, wherein the home location and the work location are determined based on the behavior pattern of the user.

7. The method according to claim 1, wherein the type of the change is a home location change.

8. The method according to claim 7, wherein the updated service information provided to the user is determined based on a change in value between a first home at a first home location and a second home at a second home location.

9. The method according to claim 1, wherein the type of the change is a work location change.

10. The method according to claim 9, wherein the updated service information provided to the user is determined based on a change in income between a previous job and a current job of the user.

11. A non-transitory computer-readable medium storing a program for automatically providing updated service information to a user based on changes in behavior of the user which, when executed on a computer, causes the computer to:
receive, from a memory, data indicating a behavior pattern of the user;
monitor mobility of the user by monitoring movements of at least one of a vehicle and a mobile telecommunication device of the user;
determine whether a change occurs in the behavior pattern based on the mobility of the user;
determine a type of the change in the behavior pattern; and
output the updated service information to at least one of the user and a third party based on the type of the change.

12. The non-transitory computer-readable medium according to claim 11, wherein, when the mobility of the user is determined by monitoring the movements of the vehicle, the mobility is determined based on telemetry data of the vehicle.

13. The non-transitory computer-readable medium according to claim 11, wherein the program, when executed on the computer, causes the computer to adapt the behavior pattern based on newly acquired mobility data.

14. The non-transitory computer-readable medium according to claim 11, wherein outputting the updated service information includes providing a notification to the user via at least one of an audio output in a vehicle, a text message to a mobile communication device, and an e-mail to the user.

15. The non-transitory computer-readable medium according to claim 11, wherein the change in the behavior pattern is determined based on a change in at least one of a home location and a work location of the user.

16. The non-transitory computer-readable medium according to claim 15, wherein the home location and the work location are determined based on the behavior pattern of the user.

17. The non-transitory computer-readable medium according to claim 11, wherein the type of the change is a home location change.

18. The non-transitory computer-readable medium according to claim 11, wherein the updated service information provided to the user is determined based on a change in value between a first home at a first home location and a second home at a second home location.

19. The non-transitory computer-readable medium according to claim 11, wherein the type of the change is a work location change.

20. The non-transitory computer-readable medium according to claim 19, wherein the updated service information provided to the user is determined based on a change in income between a previous job and a current job of the user.
